(19) United States
(12) Patent Application Publication
(10) Pub. No.: US 2009/0064311 A1
(43) Pub. Date: Mar. 5, 2009

(54) SECURE WEB INTERACTIONS USING A DESKTOP AGENT

(75) Inventors: David M. Clark, Salt Spring Island (CA); Christopher J. Taylor, Vancouver (CA); Kristinn V. Helyar, West Vancouver (CA)

Correspondence Address: FENWICK & WEST LLP, SILICON VALLEY CENTER, 801 CALIFORNIA STREET, MOUNTAIN VIEW, CA, 94041, US

(73) Assignee: Youtility Software Inc., North Vancouver (CA)

(21) Appl. No.: 12/200,808

(22) Filed: Aug. 28, 2008

Related U.S. Application Data
(60) Provisional application No. 60/968,783, filed on Aug. 29, 2007.

(51) Int. Cl. G06F 21/00

(52) U.S. Cl. 726/14

(57) ABSTRACT

An application server enables a secure network interaction. The application server receives a request for the secure network interaction from a third-party server. In response, the application server determines a security procedure, such as an authentication procedure, and a client corresponding to the secure network interaction. The client includes a secure desktop agent (SDA). The application server sends a message to the client that activates the SDA. The SDA establishes a secure connection with the application server. The SDA receives user credentials in a secure desktop environment and transmits them to the application server over the secure connection. The application verifies the user credentials and sends a digitally-signed authenticated response to the third-party server.

### CROSS REFERENCE TO RELATED APPLICATIONS

This application claims the benefit of U.S. Provisional Application No. 60/968,783, filed Aug. 29, 2007, which is incorporated by reference in its entirety.

### BACKGROUND

1. Field of Art

This invention generally relates to computer security and in particular to securing network interactions.

2. Description of the Related Art

Transactions over the Internet and other networks are subject to a wide array of threats including phishing scams, pharming attacks, and man-in-the-middle attacks. These and other typical attacks are intended to gather and exploit sensitive information (e.g., financial or identity information) from unsuspecting users. The risk associated with such threats has precluded many transactions from being executed over the Internet and other networks. Transactions that are executed are exposed to a risk of fraud.

The risks described above largely stem from the inherent nature of the Internet and the web browsers by which it is navigated. Modern web browsers are complicated software entities and incorporate scripting languages, plug-in architectures, and other characteristics that allow the functions of the browser to be controlled and extended. Such characteristics yield a large attack surface, resulting in the relative ease with which web interactions may be intercepted, redirected, and/or fraudulently elicited by malicious individuals.

To mitigate threats, websites allowing a user to execute one or more sensitive web interactions typically require the user to execute some variety of authentication procedure (e.g., supply a username and password or the equivalent). However, despite such efforts, because the authentication procedure and subsequent interactions take place over the Internet, they still involve a level of risk.

### SUMMARY

A method is disclosed for providing a secure network interaction. In one embodiment, a request for the secure network interaction is received from a server. Based on the request for the secure network interaction, a security procedure and a client are determined. A message is sent to the client, the message activating a secure desktop agent at the client. The secure desktop agent at the client is interacted with to perform the security procedure. The server is notified of successful performance of the security procedure.

A system is also disclosed for providing a secure network interaction. In one embodiment, the system includes an application server, the application server comprising a processor and a computer readable storage medium. The computer readable storage medium stores executable computer program instructions including various modules. The application server includes a website interface module adapted to receive a request for the secure network interaction from a server. The application server also includes an action identifier module adapted to determine a security procedure and a client based on the request for the secure network interaction. Additionally, the application server includes a secure desktop agent controller module adapted to send a message to the client. The message activates a secure desktop agent at the client. The secure desktop agent controller module interacts with the secure desktop agent at the client to perform the security procedure. The application server includes an action result module adapted to notify the server of successful completion of the security procedure. In one embodiment, the application server additionally includes a credential verification module adapted to receive authentication credentials to authenticate a user of the client and verify the authentication credentials.

A computer-readable storage medium is also disclosed. The computer-readable storage medium stores executable computer program instructions for performing a security procedure. In one embodiment, the computer program instructions include a communication interface module for, in response to receipt of a web page by a web browser, establishing a secure communications link with a remote server. The web page includes an action identifier (ID). The communication interface module also provides the action ID to the remote server. In response to providing the action ID to the remote server, the communication interface module receives a request to perform a security procedure from the remote server. The computer program instructions also include a user interface (UI) module for providing a UI to a user of a client for performing the requested security procedure.

### BRIEF DESCRIPTION OF DRAWINGS

FIG. 1 is a high-level block diagram of a computing environment according to one embodiment.

FIG. 2 is a high-level block diagram illustrating an example of a computer for use as an application server and/or as a client according to one embodiment.

FIG. 3 is a high-level block diagram illustrating a detailed view of an application server according to one embodiment.

FIG. 4 is a high-level block diagram illustrating a detailed view of a secure desktop agent according to one embodiment.

FIG. 5 is a sequence diagram illustrating steps involved in performing secure network interactions using a desktop agent according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

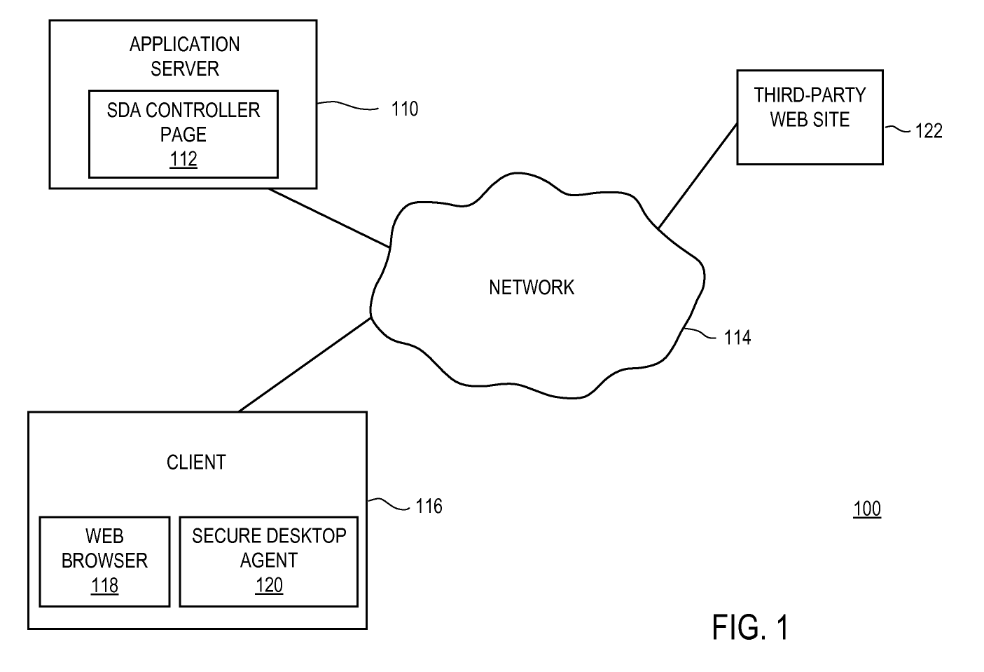

FIG. 1 is a high-level block diagram of a computing environment 100 according to one embodiment. FIG. 1 illustrates an application server 110 and a client 116 connected by a network 114. A third-party website 122 is also connected to the network 114. Only one client 116 and one third-party website 122 are shown in FIG. 1 in order to simplify and clarify the description. Embodiments of the computing environment 100 can have thousands or millions of clients 116 and/or third-party websites 122 connected to the network 114.

In one embodiment, the third-party website 122 includes a collection of one or more web pages stored on a web server. The third-party website 122 is identified by a uniform resource locator (URL). The third-party website 122 allows a user of the client 116 to carry out a secure network interaction. Though, for the sake of illustrative clarity, third-party website 122 is described herein strictly in terms of a website, in actuality the third-party website can be any entity on the network 114 that supports secure network interactions. A secure network interaction is a transaction over the network 114 involving an exchange of or access to security critical data such as usernames, passwords, social security numbers, financial account numbers, sensitive business data, etc. For example, accessing a banking website and transferring funds between accounts is a secure network interaction, and the exchanged identity and financial information are security critical data. Threats such as phishing scams, pharming attacks, and man-in-the-middle attacks often seek to compromise a secure network interaction and obtain security critical data.

The application server 110 is a network server, such as a web server, configured to support secure network interactions at one or more third-party websites 122 by performing a security procedure. In one embodiment, the security procedure is an authentication procedure. In one embodiment, the application server 110 and the third-party website 122 are operated by the same entity. In other embodiments, the application server 110 and the third-party website 122 are operated by separate entities. In such an embodiment, the operators of the third-party website 122 and the operators of the application server 110 can agree for the third-party website 122 to utilize an authentication procedure implemented by the application server 110. In one embodiment, the application server 110 hosts an SDA controller page 112. This page is downloaded by a web browser 118 to a client 116 in response to the client initiating a secure network interaction at the third party web site 122. The SDA controller page 112 interfaces and exchanges information with a secure desktop agent (SDA) 120 included in the client 116 to effect the authentication procedure.

The client 116 is a computer or other electronic device used by one or more users to perform activities including browsing websites on the network 114 such as the third-party website 122. The client 116, for example, can be a personal computer, personal digital assistant (PDA), or a mobile telephone. As shown in FIG. 1, the client 116 executes a web browser 118 that allows the user to retrieve and view content from websites and other computers on the network 114. The web browser 118 also allows the user to submit information to websites and other computers on the network 114. In one embodiment, the web browser 118 is a conventional web browser, such as MOZILLA FIREFOX or MICROSOFT INTERNET EXPLORER. The web browser 118 supports technologies including JAVASCRIPT and ACTIONSCRIPT that allow the client 116 to perform actions in response to scripts and other data sent to the web browser 118 via the network 114.

The client 116 also includes the SDA 120. In one embodiment, the SDA 120 is a discrete computer application stored and executed locally by the client 116. The SDA 120 is external to the web browser 118. That is, the SDA 120 is a program separate from the web browser 118. As will be detailed below, the SDA 120 enables a user of the client 116 to perform the authentication procedure and thereby conduct secure network interactions with the third-party website 122. The user obtains the SDA 120 from a trusted source and installs it on the client 116. In one embodiment, the user downloads the SDA 120 via the network 114 from the application server 110. In another embodiment, the user purchases or receives the SDA 120 encoded on a computer readable storage medium such as a CD or floppy disk and installs it on the client 116. In one embodiment, the SDA 120 is configured to run upon startup of the client 116. In another embodiment, the SDA 120 launches in response to the web browser 118 receiving the SDA controller page 112.

The network 114 represents the communication pathways between the application server 110, client 116, and third-party website 122. In one embodiment, the network 114 is the Internet. The network 114 can also include dedicated or private communications links that are not necessarily part of the Internet. In one embodiment, the network 114 uses standard communications technologies and/or protocols. Thus, the network 114 can include links using technologies such as Ethernet, 802.11, integrated services digital network (ISDN), digital subscriber line (DSL), asynchronous transfer mode (ATM), etc. Similarly, the networking protocols used on the network 114 can include the transmission control protocol/Internet protocol (TCP/IP), the hypertext transport protocol (HTTP), the simple mail transfer protocol (SMTP), the file transfer protocol (FTP), etc. The data exchanged over the network 114 can be represented using technologies and/or formats including the hypertext markup language (HTML), the extensible markup language (XML), etc. In addition, all or some of links can be encrypted using conventional encryption technologies such as the secure sockets layer (SSL), transport layer security (TLS), secure HTTP (HTTPS), and/or virtual private networks (VPNs). In another embodiment, the entities can use custom and/or dedicated data communications technologies instead of, or in addition to, the ones described above.

In one embodiment, the third-party website 122, the application server 110, and the SDA 120 interact to perform the authentication procedure prior to the third-party website 122 allowing a secure network interaction, reducing the risk of security threats. When the user attempts to execute a secure network interaction using the third-party website 122, the third-party website 122 sends a message to the application server 110 categorizing the secure network interaction and requesting an authentication procedure. Optionally, the message can include multiple requests related to multiple secure network interactions. The application server 110 determines an authentication procedure corresponding to the secure network interaction indicated in the message received from the third-party website 122. Next, the application server 110 uses the SDA controller page 112 to activate the SDA 120 at the user's client.

The application server 110 then communicates with the SDA 120 to request user credentials as required by the authentication procedure. The SDA 120 establishes a secure connection with the application server 110, prompts the user for the requested user credentials, and receives and transmits the user credentials to the application server 110 over the secure connection. The application server 110 verifies the user credentials and communicates the result of the verification to the SDA 120 (e.g., access granted or access denied). The SDA 120 confirms that the user wants to proceed with the secure network interaction and sends a completion message to the application server 110. The application server 110 then generates and sends a signed response to the third-party website 122 indicating completion of the authentication procedure. In one embodiment, the application server 110 also directs the web browser 118 to present the third-party website 122 to the user so the secure network interaction may proceed.

Thus, an authentication procedure for a secure network interaction is carried out in a secure desktop environment with a reduced attack surface relative to browser-based environments. As a user carries out the authentication procedure, the transaction fluidly transitions from the web-browser 118 environment to the SDA 120 and back to the web-browser 118 environment, with security critical data exchanged via a secure connection established by the SDA 120. This allows the system to be integrated into browser-based workflows while providing a robust authentication procedure to facilitate secure network interactions.

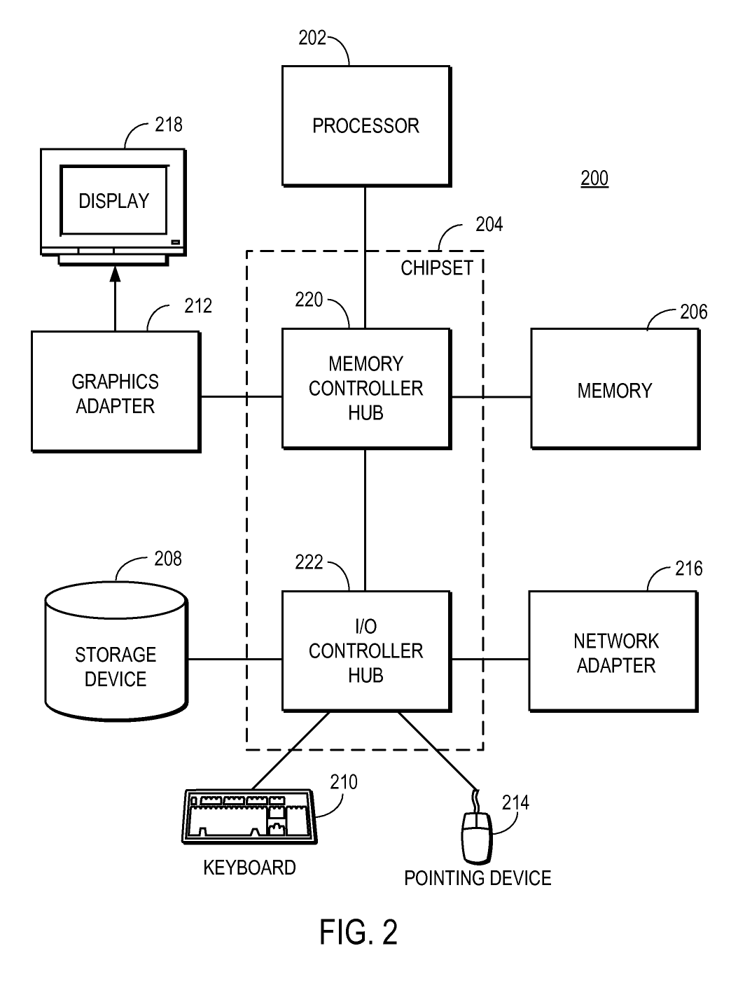

FIG. 2 is a high-level block diagram illustrating an example of a computer 200 for use as a client 116 and/or as a web server such as an application server 110. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to the network 114. Some embodiments of the computer 200 have different and/or other components than those shown in FIG. 2.

The computer 200 is adapted to execute computer program modules for providing the functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers 200 used by the entities of FIG. 1 can vary depending upon the embodiment and the processing power required by the entity. For example, a client 116 that is a mobile telephone typically has limited processing power, a small display 218, and might lack a pointing device 214. A server providing an application server 110, in contrast, might comprise multiple blade servers working together to provide the functionality described herein.

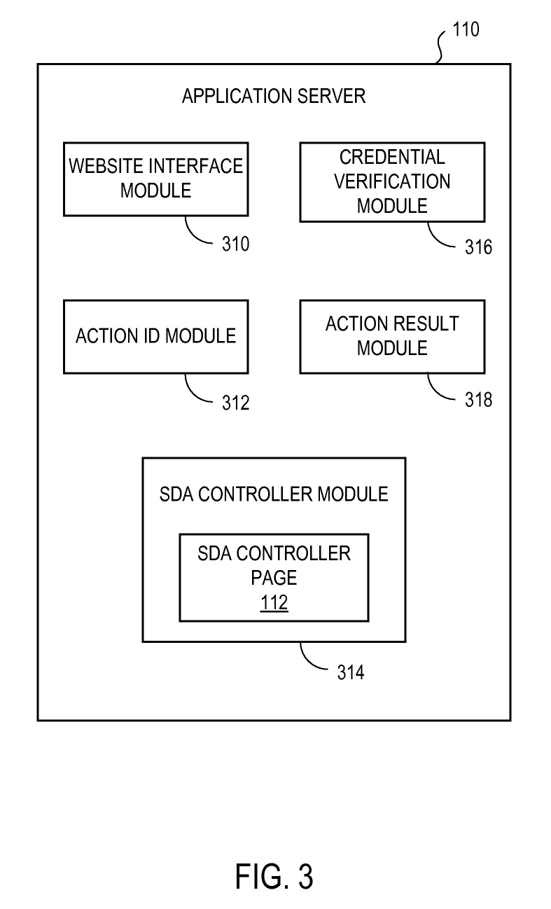

FIG. 3 is a high-level block diagram illustrating a detailed view of the application server 110 according to one embodiment. Although not explicitly shown in FIG. 3, the application server includes a processor and a computer-readable storage medium that stores executable computer program instructions. As shown in FIG. 3, the application server 110 includes several modules. Other embodiments of the application server 110 can have different and/or other modules than the ones described here. Also, the functionalities of the application server 110 can be distributed among the modules in a different manner. In addition, the functions ascribed to the application server 110 can be performed by multiple servers.

The website interface module 310 communicates with one or more third-party websites 122 over the network 114. When the user attempts to execute a secure network interaction using a third-party website 122, the third-party website 122 initiates an authentication procedure by sending a message to the application server 110 where it is received by website interface module 310. The message identifies the third-party website 122 and includes a request for an authentication procedure. In some embodiments, the message includes multiple requests related to multiple secure network interactions. Hereinafter, such a message is referred to as an action request. If, for example, the third-party website 122 is an online banking website, it can communicate to the application server 110 an action request corresponding to an attempt by a user to access an account management page. At the tail end of the authentication procedure, the website interface module 310 also sends a digitally signed authenticated response to the third-party website 122 indicating that the authentication procedure has been completed.

An action ID module 312 determines an authentication procedure and a client 116 based on the received action request. The action ID module 312 also generates a unique identifier for each instance of an action request received from a third party website 122. Hereinafter, such a unique identifier is referred to as an action ID. Hence, two separate instances of the same user attempting the same secure network interaction at the same third-party website 122 would result in the action ID module 312 generating two distinct actionIDs. In one embodiment, an actionID is a randomly generated alphanumeric string. The actionID includes no semantic content, thereby leaking no information about the action request with which it is associated. The application server 110 also stores actionIDs along with corresponding action requests in a look-up table, creating an index of corresponding action request and actionIDs. Throughout the execution of the associated authentication procedure, the actionID is included in or referenced in communications internal and external to the application server 110 and serves to identify the action.

The application server 110 also includes an SDA controller module 314. The SDA controller module 314 sends and receives messages between the application server 110 and the SDA 120 at the client 116 over the network 114. For example, after an action ID has been generated and stored by the action ID module 312, the SDA controller module 314 sends the actionID to the SDA 120. Additionally, the SDA controller module 314 sends the SDA 120 a server URL associated with the application server 110. Once the SDA 120 establishes a secure connection using the server URL, the application server 110 communicates with the SDA 120 over the secure connection through the SDA controller module 314. In one embodiment, the secure connection is an HTTPS connection.

In some embodiments, the SDA controller module 314 includes an SDA controller page 112 and interfaces with the SDA 120 using the SDA controller page 112. The application server 110 directs the web browser 118 to a URL corresponding to the SDA controller page 112. The SDA controller page 112 causes the web browser 118 to activate the SDA 120. In addition, the SDA controller page 112 provides the SDA 120 with the actionID and server URL corresponding to the action request.

The SDA controller page 112 can employ a variety of methods for activating the SDA 120. In one embodiment, the SDA controller page 112 includes computer program instructions, such as JAVASCRIPT code, that activate the SDA 120 and then redirects the web browser 118 to the third-party web site 122 when the SDA terminates execution. An embodiment of the JAVASCRIPT code hooks an Image OnLoad( ) event generated by the web browser 118. This hook causes the JAVASCRIPT to be notified when an image is successfully loaded by the browser 118. The SDA controller page 112 includes HTML code that contains an image tag identifying an image for the web browser 118 to load. The URL for this image tag references the locally-stored SDA and includes the actionID and server URL as parameters. Thus, the web browser 118 activates the SDA 120 when it attempts to load the image identified by the image tag.

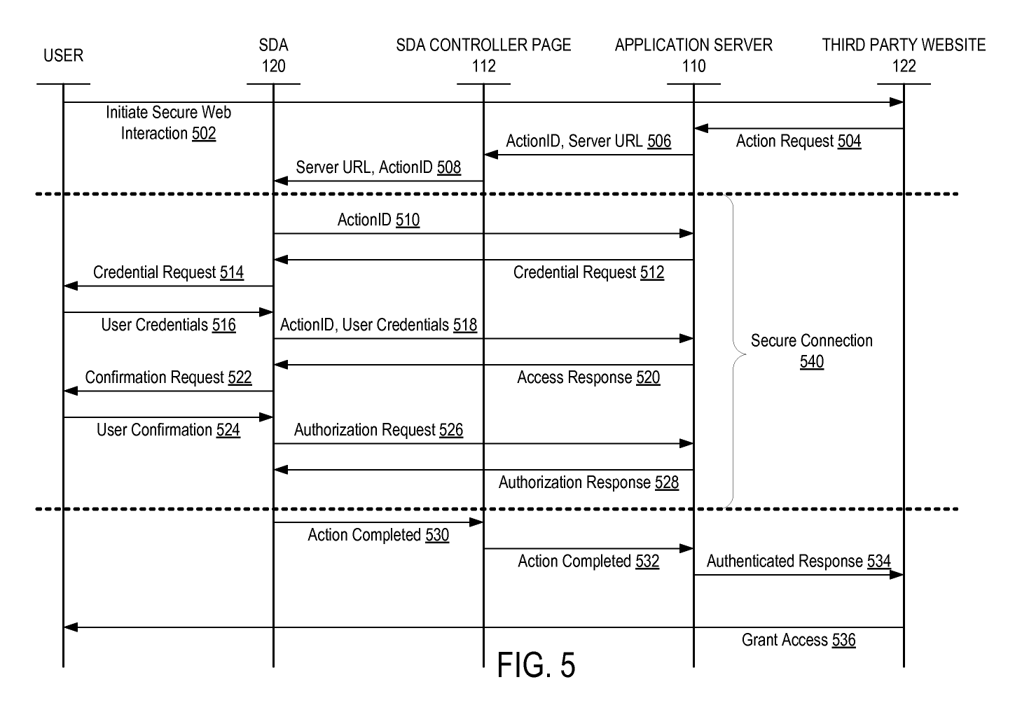

The SDA 120 uses the request to load the image as a trigger to initiate contact with the application server 110 and start the user interactions shown in FIG. 5, and uses the URL parameters as the context in which to perform these interactions. When the SDA 120 finishes processing the requested interactions, it returns the requested image to the SDA controller page 112 via the web browser 118, and then either terminates or continues to wait for the next request from the SDA controller page 112. The JAVASCRIPT code in SDA controller page 112 detects the image load due to the previously-established hook, and posts the SDA controller page 112 to the application server 110 and/or performs other actions.

In another embodiment, the computer program instructions included in the SDA controller page 112 represent a FLASH object with ACTIONSCRIPT code that implements the functionality attributed to the JAVASCRIPT code described above. The web browser 118 executes the FLASH object, which in turn activates the SDA 120 using an HTTP request that supplies the actionID and sever URL as parameters. An ACTIONSCRIPT function is called when the SDA 120 has finished processing the requested interactions and replies to the HTTP request. The ACTIONSCRIPT function causes the SDA controller page 112 to be posted to the application server 110 and/or performs other actions. In still another embodiment, the functions described above are performed by a JAVA applet that is downloaded to the web browser 118 in association with the SDA controller page 112.

In another embodiment, the computer program instructions included in the SDA controller page 112 represent JAVASCRIPT code that activates the SDA 120 using an XDomainRequest object provided by the web browser 118. The web browser 118 executes the XDomainRequest object which activates the SDA 120 using an HTTP request. The HTTP request supplies the actionID and server URL as parameters. When the SDA 120 has finished processing the requested interactions, it replies to the HTTP request. The JAVASCRIPT code in the SDA controller page 112 detects the HTTP response due to a hook previously established via an XDomainRequest.onload function, and posts the SDA controller page 112 to the application server 110 and/or performs other actions.

In still another embodiment, the computer program instructions included in the SDA controller page 112 represent JAVASCRIPT code that activates the SDA 120 using a cross site XMLHttpRequest (Level 2) object provided by the web browser 118. The web browser 118 executes the XMLHttpRequest object which activates the SDA 120 using an HTTP request. The HTTP request supplies the actionID and server URL as parameters. When the SDA 120 has finished processing the requested interactions, it replies to the HTTP request. The JAVASCRIPT code in SDA controller page 112 detects the HTTP response due to a hook previously established via the XMLHttpRequest.onload function, and posts the SDA controller page 112 to the application server 110 and/or performs other actions. Other embodiments use other web-browser provided functionality to activate the SDA 120.

The application server 110 also includes a credential verification module 316. When an action request is received, the credential verification module 316 determines what credentials a user must supply based on an authentication procedure corresponding to the action request. The credential verification module 316 communicates to the SDA 120 which credentials are required by way of the SDA controller module 314. The credential verification module 316 verifies the user-supplied credentials against stored credentials once they are sent by the SDA 120 to the application server 110 and generates a response indicating an outcome of the verification.

Depending on the sensitivity of the security critical data involved in the secure network interaction or a user's desire for security, different embodiments can employ numerous different credential verification techniques. For example, the credential verification module 316 can verify that a username and/or password or other identifier supplied by user matches a stored equivalent. Also, the credential verification module 316 can verify that a user-supplied hardware verification device, such as an encoded USB key inserted into a USB port included in the client 116, includes necessary data. Additionally, a credential verification procedure is possible wherein the credential verification module 316 contacts a network address and monitors the address for a response. An affirmative response from the network address within a certain time frame is considered a credential. For example, the credential verification module 316 dials a telephone number over the network 114 and monitors for a user response, and an affirmative user response from the dialed telephone number within a certain time frame is considered a credential. Other credential verification techniques are used in other embodiments.

Additionally, the application server 110 includes an action result module 318. If the credential verification is successful, the action result module 318 receives an authentication succeeded status from the credential verification module 316. If additional secure network interactions are pending, the statuses of these interactions are also relayed to the action result module 318. The action result module 318 receives an action completed message from an SDA 120 once the SDA 120 completes its tasks for an authentication procedure. In one embodiment, the action completed message is relayed between the SDA 120 and the action result module 318 by the SDA controller page 112 included in the SDA controller module 314. The action result module 318 generates a digitally-signed and authenticated response which notifies the third-party website 122 of the completion and the result of the secure network interaction. The action result module 318 provides this response to the website interface module 310 for transmission to the third-party website 122.

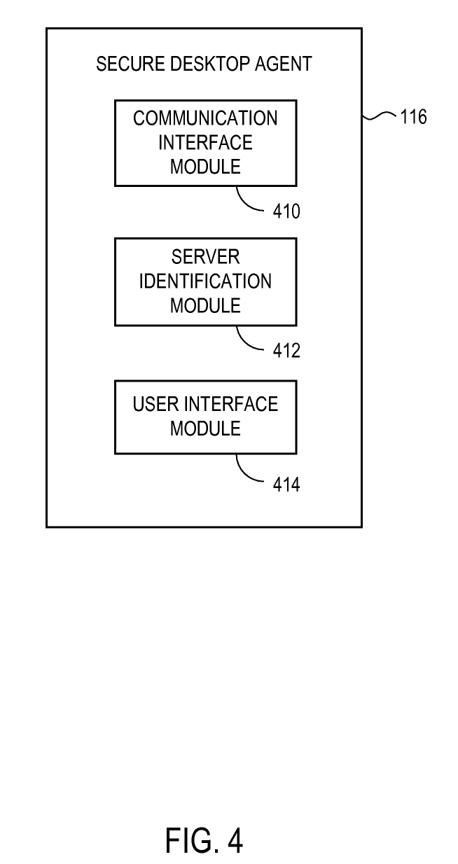

FIG. 4 is a high-level block diagram illustrating a detailed view of the SDA 120 according to one embodiment. As shown in FIG. 4, the SDA 120 includes several modules. Other embodiments of the SDA 120 can have different and/or other modules than the ones described here. Also, the functionalities of the SDA 120 can be distributed among the modules in a different manner. In addition, the functions ascribed to the SDA 120 can be performed by multiple applications.

The communication interface module 410 allows the SDA 120 to communicate with the application server 110 over the network 114. Particularly, the communication interface module 410 creates a secure communications link, such as an HTTPS connection, between the SDA 120 and a server URL provided by the application server 110. Messages between the SDA 120 and the application server are sent or received by the communication interface module 410.

The SDA 120 includes a server identification module 412 to ensure that the SDA communicates with only trustworthy entities over the network 114. The server identification module 412 includes a stored list of valid server URLs associated with the application server 110. Hence, when the SDA 120 receives a server URL from the application server 110, the server identification module 412 compares it against the stored list to verify that it is in fact a valid server URL. The communication interface module 410 establishes secure connections between the SDA 120 and only URLs contained in the stored list of valid server URLs maintained by the server identification module 412.

Additionally, the SDA 120 includes a user interface module 414. The user interface module 414 handles tasks related to user interaction with the SDA. For example, the user interface module 414 provides an interface to the user via the display 218 of the client 116. In one embodiment, the interface is a complete graphical user interface (GUI) including interactive features such as dialog boxes, data submission fields, selectable icons, and checkboxes to receive user input. The user interface module 414 uses the GUI to prompt the user for credentials as requested by the application server 110. Through the GUI, the user interface module 414 can also receive user credentials such as usernames and passwords, inform the user of operation outcomes, and confirm the user's desire to proceed with secure network interactions and associated authentication procedures.

FIG. 5 is a sequence diagram illustrating steps involved in performing secure network interactions using the SDA 120 according to one embodiment. In the diagram, five vertical lines respectively represent the user, the SDA 120, the SDA controller page 112, the application server 110, and the third-party website 122. Time flows from the top to the bottom of the figure and the horizontal lines between the entities represent communications. Other embodiments can perform the steps of FIG. 5 in different orders. Moreover, other embodiments can include different and/or additional steps and communications than the ones described here.

The user operates a client 116 to initiate 502 a secure network interaction with the third-party website 122. For example, the user uses the client's 116 web browser 118 to access a web page included in the third-party website 122 and requests to perform a secure network interaction. In response, the third-party website 122 sends 504 an action request to the application server 110. In one embodiment, the third-party website 122 sends 504 the action request by redirecting the web browser 118 to a URL associated with the application server 110. Embedded in the URL is an action request. Hence, responsive to the web browser 118 accessing the URL, the application server 110 generates an actionID to uniquely identify the secure network interaction corresponding to the action request. The application server 110 stores the actionID along with the corresponding action request in a look-up table. The application server 110 sends 506 the actionID and the server URL to the SDA controller module 314 and redirects the web browser 118 to the SDA controller page 112. The SDA controller page 112 sends 508 the actionID along with a server URL associated with the application server 110 to the SDA 120.

Within the SDA 120, the server identification module 410 verifies the legitimacy of the server URL associated with the application server 110 sent 508 by the SDA controller page 112. If the sent 508 server URL is legitimate, the SDA 120 uses it to establish a secure connection 540 with the application server 110, thereby creating a secure environment in which security critical data may be exchanged. Once the secure connection 540 has been created, the SDA 102 sends 510 the actionID back to the application server 110 via the secure connection 540. The application server 110 accesses the look-up table and determines the action request corresponding to the actionID. The application server 110 replies 512 to the SDA 120 with a credential request, specifying to the SDA 120 what credentials are required for the authentication procedure corresponding to the action request. The SDA then presents 514 a credential request to the user via the display 218 of the client 116. The user provides 516 the requested credentials to the SDA 120.

After the user provides 516 the credentials, the SDA 120 sends 518 the credentials and the associated actionID to the application server 110 over the secure connection. The application server 110 verifies the credentials and sends 520 an access response to the SDA 120 indicating whether the credentials provided 516 by the user are sufficient for the authentication procedure corresponding to the actionID. If the credentials are sufficient, the SDA 120 presents 522 a confirmation request to the user to confirm the user's desire to proceed with the secure network interaction. The user confirms 524 his desire to proceed, and the SDA 120 sends 526 an authorization request to the application server 110 to indicate the outcome of the user confirmation. The application server 110 responds 528 to the SDA 120 with an authorization response permitting the SDA 120 to complete the authentication procedure. The SDA 120 then sends 530 an action completed message to the SDA controller page 112 by replying to the image request or other HTTP request from the SDA controller page 112, and either terminates or waits for the next 508 request from the SDA controller page 112. The SDA controller page 112 sends 532 an action completed message to the application server 110.

The application server 110 then generates a signed and authenticated response and sends 534 it to the third-party website 122 to verify that the user has successfully authenticated. In one embodiment, the application server 110 also redirects the web browser 118 to the third-party website 122. In one embodiment, the application server 110 issues a redirect command to the third-party website 122 containing the signed and authenticated response. Having received the signed and authenticated response, the third party website grants access 536 for the user to perform the secure network interaction.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method for providing a secure network interaction, the method comprising:
receiving from a server a request for the secure network interaction;
determining a security procedure and a client based on the request for the secure network interaction;
sending a message to the client, the message activating a secure desktop agent at the client;
interacting with the secure desktop agent at the client to perform the security procedure; and
notifying the server of successful performance of the security procedure.

2. The method of claim 1, wherein sending a message to the client comprises:
providing the client with a web page that, when received by a web browser executing on the client, causes the web browser to activate the secure desktop agent at the client.

3. The method of claim 2, wherein the provided web page instructs the web browser to load an image at a specified address on the client, and wherein the web browser activates the secure desktop agent by attempting to load the image at the specified address.

4. The method of claim 3, wherein the provided web page further includes computer program instructions that, when executed, cause the web browser to notify the computer program instructions if the web browser loads an image and wherein the secure desktop agent provides an image to the web browser responsive to performance of the security procedure.

5. The method of claim 4, wherein the computer program instructions further cause the web browser to communicate with the server from which the request for the secure network interaction was received responsive to receiving notification that the web browser loaded an image.

6. The method of claim 2, wherein the provided web page causes the web browser to activate the secure desktop agent by executing an XDomainRequest object.

7. The method of claim 6, wherein the XDomainRequest object issues an HTTP request to the secure desktop agent, and wherein the provided web page further includes computer program instructions that, when executed, cause the web browser to notify the computer program instructions if the secure desktop agent responds to the HTTP request.

8. The method of claim 7, wherein the computer program instructions further cause the web browser to communicate with the server from which the request for the secure network interaction was received responsive to receiving notification that the secure desktop agent responded to the HTTP request.

9. The method of claim 2, wherein the provided web page causes the web browser to activate the secure desktop agent by executing a cross-site XMLHttpRequest object.

10. The method of claim 11, wherein the cross-site XMLHttpRequest object issues an HTTP request to the secure desktop agent, and wherein the provided web page further includes computer program instructions that, when executed, cause the web browser to notify the computer program instructions if the secure desktop agent responds to the HTTP request.

11. The method of claim 10, wherein the computer program instructions further cause the web browser to communicate with the server from which the request for the secure network interaction was received responsive to receiving notification that the secure desktop agent responded to the HTTP request.

12. The method of claim 1, wherein sending a message to the client comprises providing the client with a uniform resource locator (URL) and an action identifier (ID), and wherein interacting with the secure desktop agent comprises:
establishing a secure network connection with the secure desktop agent using the URL; and
receiving the action ID from the secure desktop agent via the secure network connection.

13. The method of claim 1, wherein the security procedure comprises an authentication procedure and wherein interacting with the secure desktop agent comprises:
receiving authentication credentials to authenticate a user of the client; and
verifying the authentication credentials.

14. The method of claim 1, wherein the security procedure is performed by an application server and wherein notifying the server of successful performance of the security procedure comprises:
providing the server with an authenticated response digitally-signed by the application server.

15. A system for executing an authentication procedure to enable a secure network interaction at a website, the system comprising:
an application server, the application server comprising a processor and a computer readable storage medium, the computer readable storage medium storing executable computer program instructions comprising:
a website interface module configured to receive from a server a request for the secure network interaction;
an action identifier module configured to determine a security procedure and a client based on the request for the secure network interaction;
a secure desktop agent controller module configured to send a message to the client, the message activating a secure desktop agent at the client, and interact with the secure desktop agent at the client to perform the security procedure; and
an action result module configured to notify the server of successful performance of the security procedure.

16. The system of claim 15, wherein the secure desktop agent controller module is further configured to send the message to the client by providing the client with a web page that, when received by a web browser executing on the client, causes the web browser to activate the secure desktop agent at the client.

17. The system of claim 16, wherein the provided web page instructs the web browser to load an image at a specified address on the client, and wherein the web browser activates the secure desktop agent by attempting to load the image at the specified address.

18. The system of claim 17, wherein the provided web page further includes computer program instructions that, when executed, cause the web browser to notify the computer program instructions if the web browser loads an image and wherein the secure desktop agent provides an image to the web browser responsive to performance of the security procedure.

19. The system of claim 18, wherein the computer program instructions further cause the web browser to communicate with the server from which the request for the secure network interaction was received responsive to receiving notification that the web browser loaded an image.

20. The system of claim 15, wherein the secure desktop agent controller module is further adapted to provide the client with a uniform resource locator (URL) and an action identifier (ID) and interact with the secure desktop agent by:
establishing a secure network connection with the secure desktop agent using the URL; and
receiving the action ID from the secure desktop agent via the secure network connection.

21. The system of claim 15, wherein the security procedure comprises an authentication procedure and wherein:
the application server further comprises a credential verification module adapted to receive authentication credentials to authenticate a user of the client and verify the authentication credentials.

22. The system of claim 15, wherein the action result module is further configured to notify the server of successful performance of the security procedure by providing the server with an authenticated response digitally-signed by the action result module.

23. A computer-readable storage medium storing executable computer program instructions for performing a security procedure, the computer program instructions comprising:
a communication interface module for establishing a secure communications link with a remote server responsive to receipt of a web page by a web browser, the web page including an action identifier (ID), for providing the action ID to the remote server, and for receiving a request to perform a security procedure from the remote server responsive to providing the action ID; and
a user interface (UI) module for providing a UI to a user of a client for performing the requested security procedure.

24. The computer-readable storage medium of claim 23, wherein the web page received by the communication interface module further includes a uniform resource locator (URL), the computer program instructions further comprising:
a server identification module for determining whether the URL is valid;
wherein the communication interface module is adapted to establish a secure network connection using the URL responsive to a determination that the URL is valid.

25. The computer-readable storage medium of claim 24, wherein determining whether the URL is valid comprises determining whether the URL is listed within a list of valid URLs.

26. The computer-readable storage medium of claim 23, wherein the security procedure comprises a user authentication and wherein the UI module is adapted to provide a UI for receiving user credentials from the user.
